(19) United States
(12) Patent Application Publication
(10) Pub. No.: US 2019/0241129 A1
(43) Pub. Date: Aug. 8, 2019

(54) TERMIN/AL SUPPORTER MOUNTABLE TO VEHICLE VENTILATOR

(71) Applicant: CPC Co., Ltd., Hwaseong-si (KR)

(72) Inventor: Soon Young SONG, Anyang-si (KR)

(73) Assignee: CPC Co., Ltd., Hwaseong-si (KR)

(21) Appl. No.: 15/889,140

(22) Filed: Feb. 5, 2018

(51) Int. Cl. B60R 11/02

(52) U.S. Cl. CPC B60R 11/0241; B60R 2011/0008

(57) ABSTRACT

Disclosed is a terminal supporter mountable to a vehicle ventilator, and more particularly to a terminal supporter mountable to a vehicle ventilator, which is configured to strongly tighten a front end and a rear end of a ventilator slat up after being inserted in the vehicle ventilator, so that the terminal supporter can be prevented from being separated from the vehicle ventilator and being moved or shaken within the vehicle ventilator, thereby maintaining a stable and solid mounting state.

### BACKGROUND OF THE INVENTION

### (a) Field of the Invention

The present disclosure relates to a terminal supporter mountable to a vehicle ventilator, and more particularly to a terminal supporter mountable to a vehicle ventilator, which is configured to strongly tighten a front end and a rear end of a ventilator slat up after being inserted in the vehicle ventilator, so that the terminal supporter can be prevented from being separated from the vehicle ventilator and being moved or shaken within the vehicle ventilator, thereby maintaining a stable and solid mounting state.

### (b) Description of the Related Art

With recent rapid development and popularization of wireless mobile communication technology, a cellular phone and the like terminal have been widely spread, and thus various supporters has been released to improve use convenience while driving a vehicle. Such a supporter is a tool for basically holding a terminal at a certain position, and includes a mounting module for mounting the terminal to an installed place, and a cradle for holding the terminal.

The conventional terminal supporter for a vehicle is installed on a dashboard or the like of the vehicle, and causes problems of interrupting safe driving since a frontward view is blocked and inflicting an injury on a passenger by the firmly-fixed terminal supporter at a vehicle accident. Further, the conventional terminal supporter for a vehicle is not freely movable, and it is thus inconvenient to control the terminal.

To solve these problems, there has been disclosed technology of mounting the terminal to a ventilator of a vehicle, but this technology is insufficient to ensure both safety and convenience and thus required to be more improved.

Korean Patent No. 10-1493433 (hereinafter, referred to as the “prior art”) is related to a smartphone holder for a vehicle as shown in FIG. 2, and proposes a smart phone holder for a vehicle, which includes a mounting module 100 fitted and coupled to a vehicle ventilator 1, a cradle 300 for holding the smart phone terminal 400, and a connection member 200 for connecting the mounting module 100 and the cradle 300 as shown in FIG. 1.

In such a smart phone holder for a vehicle according to the prior art, a pair of clamps 110 of the mounting module 100 is inserted in the vehicle ventilator 1 and holds the ventilator slat, but the pair of clamps 110 does not strongly tighten the front and rear ends of the ventilator slat. Therefore, the holder is moved or shaken within the ventilator, and it is impossible to keep a stable and firm mounting state.

### SUMMARY OF THE INVENTION

Accordingly, the present disclosure is conceived to solve the foregoing problems, and an aspect of the present disclosure is to provide a terminal supporter mountable to a vehicle ventilator, which is configured to strongly tighten a front end and a rear end of a ventilator slat up after being inserted in the vehicle ventilator, so that the terminal supporter can be prevented from being separated from the vehicle ventilator and being moved or shaken within the vehicle ventilator, thereby maintaining a stable and solid mounting state.

In accordance with an embodiment of the present disclosure, there is provided a terminal supporter mountable to a vehicle ventilator, which includes a mounting module inserted in and mounted to the vehicle ventilator, and a cradle connected to the mounting module and supporting and holding a terminal, the mounting module including: a support bracket arranged to be in contact with and supported on front ends of ventilator slats from an outside of the vehicle ventilator; a sliding coupling body arranged to slide and move through an insertion sliding hole formed in the support bracket, and including a hook at a first side to be inserted in the vehicle ventilator and hooked to a rear end of the ventilator slat, and a joint at a second side to which the cradle is detachably connected; and a slide-driving rotary body screw-coupling with the sliding coupling body while surrounding the sliding coupling body, guided by and rotatably coupled to a second side of the support bracket, and rotating to drive the sliding coupling body to slid and move.

The sliding coupling body may be formed with a sliding guide groove along a sliding direction, and the insertion sliding hole of the support bracket may be formed with a sliding guide rail to be inserted in and guided by the sliding guide groove along the sliding direction.

The support bracket may be formed with an internally penetrated rotation guide cylinder at the second side, and the rotation guide cylinder may be formed with a rotation guide rail shaped like a ring laterally protruding from a top end; and the slide-driving rotary body may be formed with a rotation guide supporter arranged to be adjacent to and surround the rotation guide cylinder at a lower inside, and the rotation guide supporter may be formed with a rotation guide groove laterally recessed at an upper end to accommodate and guide the rotation guide rail.

### BRIEF DESCRIPTION OF THE DRAWINGS

The above and/or other aspects of the present disclosure will become apparent and more readily appreciated from the following description of the exemplary embodiments, taken in conjunction with the accompanying drawings, in which:

FIG. 1 is a perspective view of schematically showing the interior of a vehicle;

FIG. 2 is a perspective view of a conventional terminal holder mountable to a vehicle ventilator;

FIG. 3 is an assembled perspective view of a mounting module in a terminal supporter mountable to a vehicle ventilator according to one embodiment of the present disclosure,

FIGS. 4 and 5 are exploded perspective views of the mounting module; and

FIG. 6 is a cross-section view for explaining use aspects of a mounting module in a terminal supporter mountable to a vehicle ventilator according to one embodiment of the present disclosure.

### DETAILED DESCRIPTION

Below, embodiments of a terminal supporter mountable to a vehicle ventilator according to the present disclosure with the foregoing objects, solutions, and effects will be described in detail with reference to the accompanying drawings.

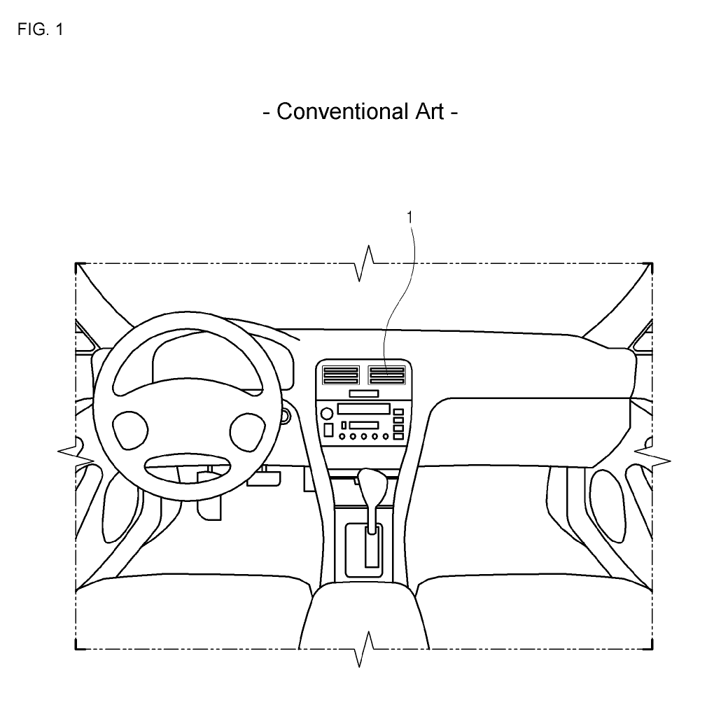

According to one embodiment of the present disclosure, a terminal supporter mountable to a vehicle ventilator includes a mounting module 100 inserted in and mounted to the vehicle ventilator 1 (refers to FIG. 1), and a cradle (not shown) connected to the mounting module 100 and supporting and holding a terminal. That is, according to one embodiment of the present disclosure, the terminal supporter mountable to the vehicle ventilator includes the mounting module 100 inserted in the vehicle ventilator 1 and maintaining a stable posture, and the cradle connected to the mounting module 100 and stably supporting a terminal.

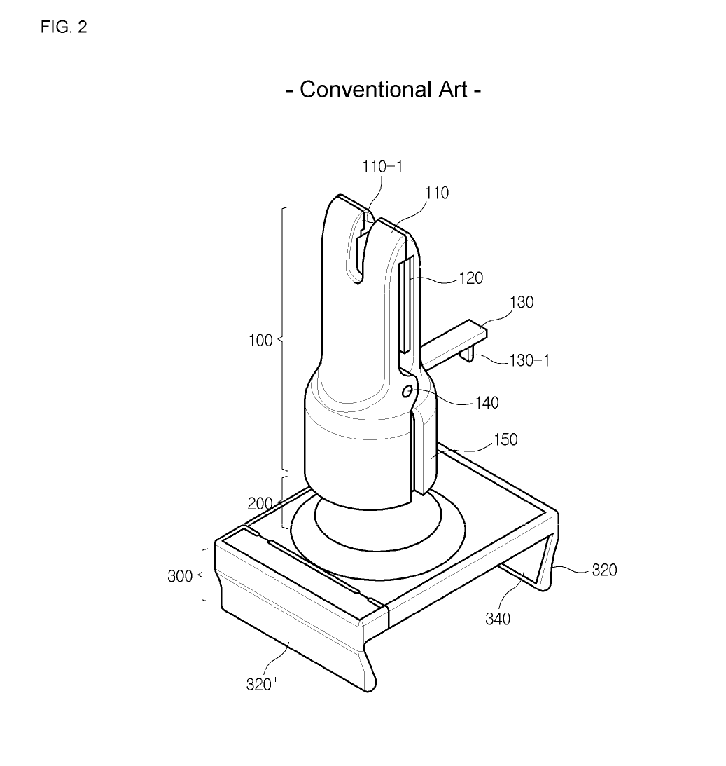

The cradle may have various structures as long as it can support and stably hold a terminal. However, the cradle is detachably connected to the mounting module 100, and coupled to be rotatable in various directions (at 360 degrees) or oriented toward various positions. Specifically, the cradle may have the same or similar shape as the cradle 300 of the conventional terminal supporter shown in FIG. 2, and coupled to the mounting module 100 with a structure to be rotatable at 360 degrees, for example, by a ball joint method.

For such a ball-joint connecting method, the mounting module 100 may be provided with a ball-type joint 35, and the cradle may be formed with a ball mounting bracket (not shown) which accommodates and settling a joint ball corresponding to the joint 35. After the joint ball is forcibly fitted to the ball mounting bracket, a detachable cap (not shown) is screw-coupled to an outer circumference of the ball mounting bracket so that the joint ball can be held within the ball mounting bracket.

By such a ball-joint connecting method, the cradle can be rotated by a user in various directions and at various angles with respect to the joint 35 of the mounting module 100, and the ball mounting bracket is tightened up with the detachable cap after being rotated in a desired direction and at a desired angle and thus strongly fastened and coupled to the mounting module 100.

Like this, the cradle may be formed to have various structures as long as it can hold the terminal, and connected to the mounting module 100 by the ball-joint connecting method using the joint ball, the ball mounting bracket, the detachable cap, etc.

The mounting module 100 has a first side to be inserted in and stably mounted to the vehicle ventilator 1, and a second side for stably holding and coupling the cradle at various angles through the joint 35 formed at a second side of the sliding coupling body 30 to be described in detail later. The mounting module 100 will be described in detail.

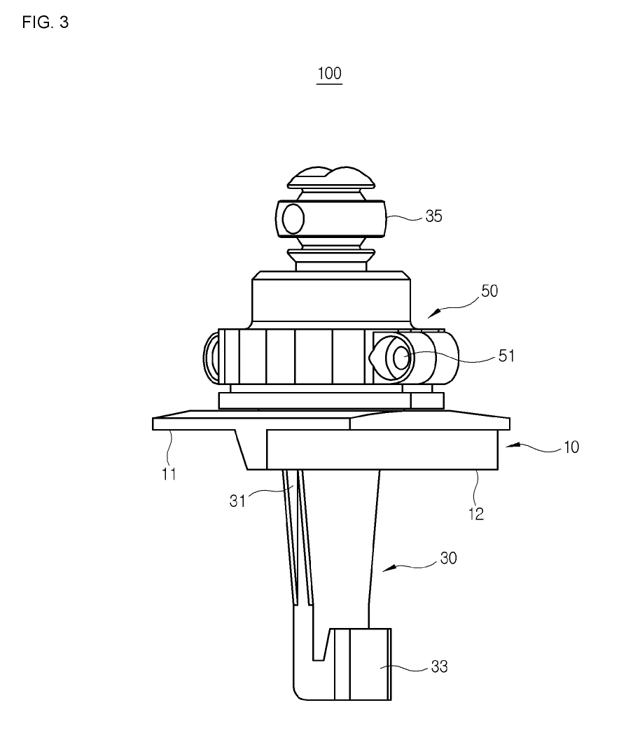

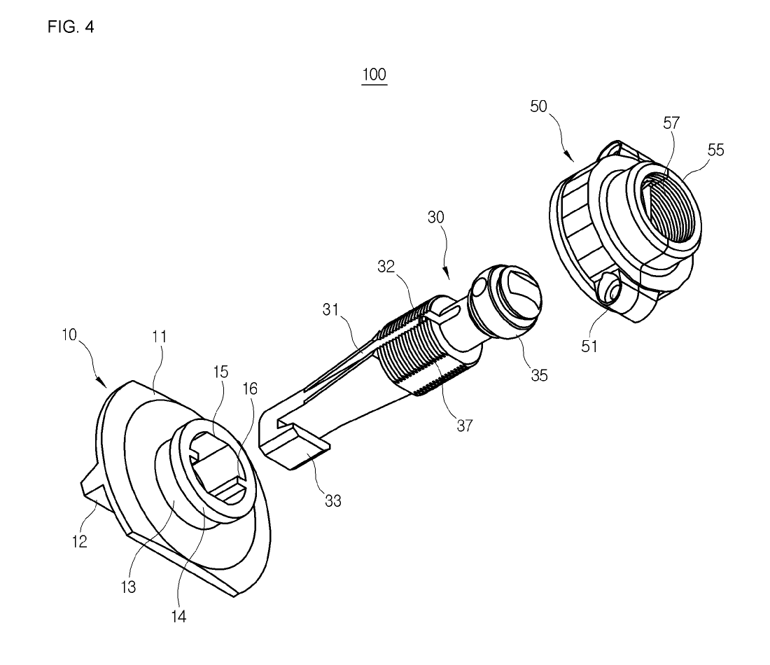

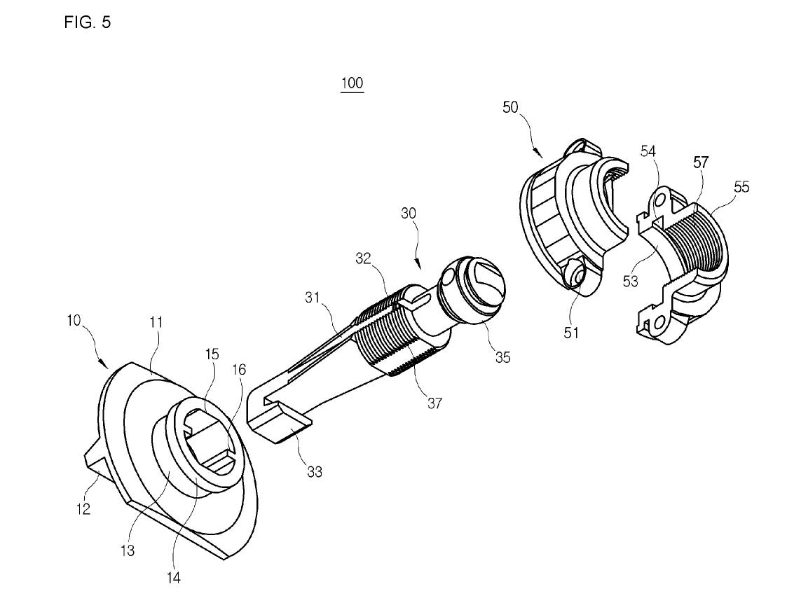

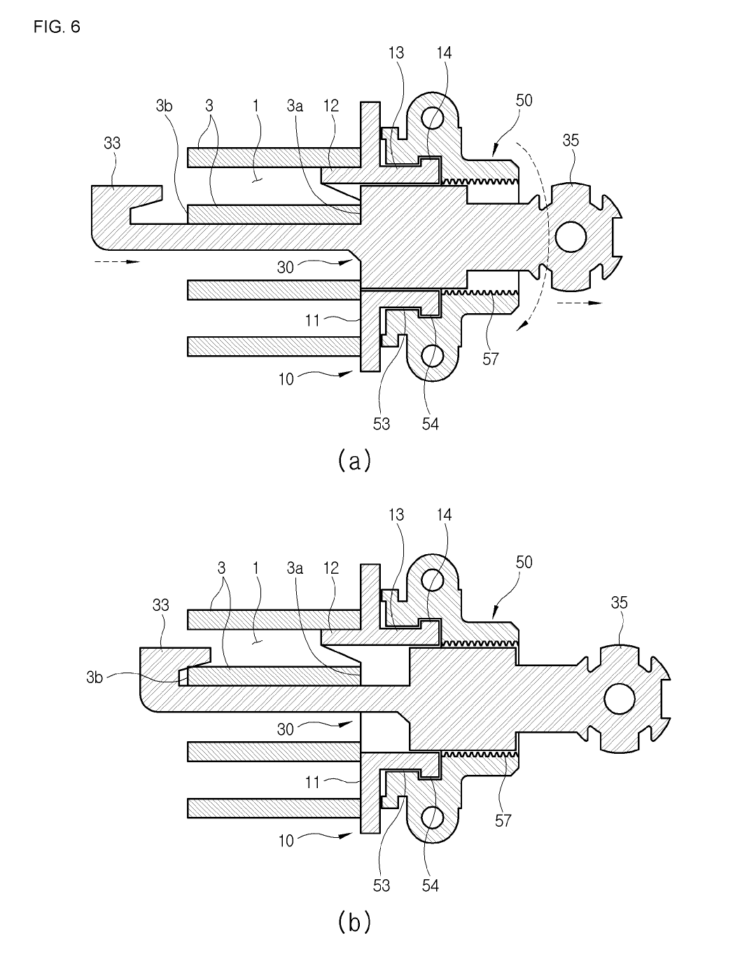

FIG. 3 is an assembled perspective view of a mounting module in a terminal supporter mountable to a vehicle ventilator according to one embodiment of the present disclosure, and FIGS. 4 and 5 are exploded perspective views of the mounting module; and FIG. 6 is a cross-section view for explaining use aspects of the mounting module.

As shown in FIGS. 3 to 6, the mounting module 100 according to the present disclosure includes a support bracket 10 being in contact with and supported on a ventilator slat 3 from the outside of the vehicle ventilator 1, a sliding coupling body 30 arranged to slide as it is guided by the support bracket 10, and a slide-driving rotary body 50 screw-coupled with the sliding coupling body 30 and rotating to drive the sliding coupling body 30 slide.

As shown in FIG. 6, the support bracket 10 is arranged to be in contact with and supported on front ends 3a of the ventilator slats 3 from the outside of the vehicle ventilator 1. That is, the support bracket 10 is arranged to be in contact with and supported on the entrance of the vehicle ventilator 1, and thus arranged to be in contact with and supported on front ends 3a of a plurality of ventilator slats 3 (i.e. the end of the ventilator slat exposed to the outside of the vehicle ventilator 1) horizontally arranged in parallel with one another in a vertical direction within the vehicle ventilator 1.

The support bracket 10 is formed with an insertion sliding hole 15 at the center thereof. Through the insertion sliding hole 15, the sliding coupling body 30 is guided to slide and move. The sliding coupling body 30 is shaped like a long rod or stick, and is formed with an outer screw-coupling portion 37 in the middle thereof to screw-couple with the slide-driving rotary body 50; a hook 33 at a first side thereof (i.e. in a direction of being inserted in the vehicle ventilator 1) to be hooked to the rear end 3b corresponding to the inner end of the ventilator slat 3, and the joint 35 at the second side thereof (i.e. in a direction of being coupled with the cradle) to detachably couple with the cradle.

Like this, the sliding coupling body 30 is arranged to slide and move through the insertion sliding hole 15 formed in the support bracket 10, in which the hook 33 is formed at the first side, inserted in the vehicle ventilator 1, and hooked to the rear end 3b of the ventilator slat 3, and the joint 35 is formed at the second side to which the cradle is detachably connected.

The sliding coupling body 30 can be inserted into the vehicle ventilator 1 through the insertion sliding hole 15 since it is arranged to slid and move through the insertion sliding hole 15 formed in the support bracket 10 arranged to be in contact with and supported on a vehicle ventilator entrance from the outside of the vehicle ventilator 1.

The first side of the sliding coupling body 30 to be inserted in the vehicle ventilator 1 is formed with the hook 33 having a hook shape. That is, the hook 33 is formed at the first side of the sliding coupling body 30. When the sliding coupling body 30 moves backward (i.e. in an outward direction of the vehicle ventilator 1 as the slide-driving rotary body 50 rotates in the state that the hook 33 is sufficiently inserted in the vehicle ventilator 1 (see (a) of FIG. 6), the hook 33 is in close contact with and hooked to the rear end 3b of the ventilator slat 3 (see (b) of FIG. 6).

In result, the mounting module 100 according to the present disclosure can be firmly and stably maintained without shaking while being inserted in the vehicle ventilator 1, since not only the front end 3a of the ventilator slat 3 is in close contact with and supported by the support bracket 10 but also the rear end 3b of the ventilator slat 3 is in close contact with and hooked and supported by the hook 33.

To drive the sliding coupling body 30 to move forward or backward, the slide-driving rotary body 50 is rotatably coupled to the support bracket 10 without separation and screw-coupled to the sliding coupling body 30. That is, the slide-driving rotary body 50 according to the present disclosure is screw-coupled to the sliding coupling body 30 while surrounding the sliding coupling body 30, and is also guided by and rotatably coupled to a second side of the support bracket 10 (i.e. opposite to a first side being in contact with and supported on the vehicle ventilator 1), thereby driving the sliding coupling body 30 to slide and move when the slide-driving rotary body 50 is rotated by a user.

Since the slide-driving rotary body 50 screw-couples with the sliding coupling body 30 as above, the sliding coupling body 30 can slide and move forward or backward while being guided in the insertion sliding hole 15 formed in the support bracket 10 when a user rotates the slide-driving rotary body 50 in one direction or the other direction. In addition, the slide-driving rotary body 50 has a structure of rotating in place without separation from the second side of the support bracket 10 and coupling with the second side of the support bracket 10, and is thus rotated by a user to make the sliding coupling body 30 move forward or backward.

With these structures and operations, the terminal supporter mountable to the vehicle ventilator according to the present disclosure is configured to strongly tighten both the front end 3a and the rear end 3b of the ventilator slat 3 up after being inserted in the vehicle ventilator 1, and is thus prevented from separation from the vehicle ventilator 1 and from moving or shaking within the vehicle ventilator 1, thereby having effects on maintaining a stable and firm mounting state.

Below, the structures and operations of the elements in the mounting module 100 of the terminal supporter mountable to the vehicle ventilator according to the present disclosure will be described in detail.

The support bracket 10 includes a contact support plate 11 shaped like a plate formed with an opening hole; an insertion support piece 12 protruding from the first side of the contact support plate 11 (i.e. the side to be in contact with and supported on the vehicle ventilator 1); and a rotation guide cylinder 13 shaped like a cylinder protruding from the second side of the contact support plate 11 and communicating with the opening hole. The contact support plate 11 is shaped like a plate formed with the opening hole at an approximately center. The insertion support piece 12 is formed in the support bracket 10, specifically, on the first side of the contact support plate 11, and the rotation guide cylinder 13 is formed on the second side.

The insertion support piece 12 is kept interposed between the adjacent ventilator slats 3 while the contact support plate 11 is arranged being in contact with and supported on the entrance of the vehicle ventilator 1, and inserted in the vehicle ventilator 1 while maintaining surface contact with the ventilator slat 3 when the front end 3a and the rear end 3b of the ventilator slat 3 are contact-supported and tightened up by the contact support plate 11 and the hook 33. In result, the mounting module 100 according to the present disclosure keeps a more stable state with the additional reinforcing support of the contact support plate 11 when it is inserted in and mounted to the vehicle ventilator 1, and more particularly reinforces stability and solidity in a vertical direction.

The second side of the support bracket 10 (i.e. the second side of the contact support plate 11) is formed with the rotation guide cylinder 13 having an internal hollow space, and a top end of the rotation guide cylinder 13 is formed with a rotation guide rail 14. That is, the rotation guide cylinder 13 is formed on the second side of the support bracket 10 (i.e. the second side of the contact support plate 11) and internally penetrated, and the rotation guide rail 14 shaped like a ring laterally protruding from the top end of the rotation guide cylinder 13.

Thus, the first side of the sliding coupling body 30 is guided to slide through the internal hollow space of the rotation guide cylinder 13, and the slide-driving rotary body 50 is guided to rotate through the outer portion of the rotation guide cylinder 13. Further, the rotation guide rail 14 prevents the slide-driving rotary body 50 from separation while the slide-driving rotary body 50 rotates in place.

In addition, the slide-driving rotary body 50 is internally formed with a rotation guide supporter 53 and a rotation guide groove 54 respectively corresponding to the rotation guide cylinder 13 and the rotation guide rail 14. Specifically, the rotation guide supporter 53 is formed in a lower inside of the slide-driving rotary body 50 and is arranged to be adjacent to and surround the rotation guide cylinder 13, and the rotation guide groove 54 is formed in an upper end of the rotation guide supporter 53 and laterally recessed to accommodate and guide the rotation guide rail 14.

With this structure, when the lower inside of the slide-driving rotary body 50 is coupled to and surrounds the rotation guide cylinder 13 formed at the second side of the support bracket 10, the rotation guide cylinder 13 can guide the rotation guide supporter 53 in the state that the rotation guide rail 14 is inserted in the rotation guide groove 54. Therefore, when a user rotates the slide-driving rotary body 50, the slide-driving rotary body 50 can rotate in place without separation from the rotation guide cylinder 13 and the rotation guide rail 14.

As described above, the rotation guide cylinder 13 of the support bracket 10 is internally penetrated. That is, the rotation guide cylinder 13 has the insertion sliding hole 15. Through the insertion sliding hole 15 of the rotation guide cylinder 13, the sliding coupling body 30 is guided to slide.

To this end, the insertion sliding hole 15 of the support bracket 10 (i.e. the rotation guide cylinder 13) is formed with a sliding guide rail 16 along a sliding direction for guiding the sliding coupling body 30. Correspondingly, the sliding coupling body 30 is formed with a sliding guide groove 31, in which the sliding guide rail 16 is inserted to slide, along the sliding direction.

In brief, the sliding coupling body 30 is formed with the sliding guide groove 31 along the sliding direction, and the insertion sliding hole 15 of the support bracket 10 (i.e. the rotation guide cylinder 13 is formed with the sliding guide rail 16, inserted in and guided by the sliding guide groove 31, along the sliding direction.

The sliding coupling body 30 couples with the insertion sliding hole 15 so that the sliding guide rail 16 formed in the insertion sliding hole 15 of the support bracket 10 (i.e. the rotation guide cylinder 13) can be inserted in and guided by the sliding guide groove 31. Therefore, when a user rotates the slide-driving rotary body 50, the sliding coupling body 30 does not rotate but moves forward or backward through the insertion sliding hole 15 in the sliding direction.

The sliding coupling body 30 is shaped like a rod or stick as described above, and has the first side formed with the hook 33 and the second side formed with the joint 35. Further, the sliding coupling body 30 is formed with the outer screw-coupling portion 37 in a middle portion thereof to screw-couple with the slide-driving rotary body 50. The outer screw-coupling portion 37 is circumferentially threaded to screw-couple with an inner screw-coupling portion 57 formed on an inner surface of a rotary coupling hole 55 of the slide-driving rotary body 50.

As described above, the sliding coupling body 30 has the sliding guide groove 31 formed along a lengthwise direction (i.e. the sliding direction). The sliding coupling body 30 is fastened to slide and move in such a manner that the sliding guide rail 16 formed in the insertion sliding hole 15 can be inserted in the sliding guide groove 31.

By the way, when the slide-driving rotary body 50 is excessively rotated only in one direction or the other direction while a user controls the mounting module 100, the sliding coupling body 30 continues to move forward or backward and separates from the support bracket 10, i.e. the insertion sliding hole 15 of the rotation guide cylinder 13.

To prevent such a situation, the sliding guide groove 31 may be formed with a sliding stopper 32. The sliding stopper 32 serves to stop the sliding guide rail 16 from moving when the sliding coupling body 30 continues to slide only in one direction or the other direction. Specifically, the sliding stopper 32 is provided in at least one of an upper side and a lower side of the sliding guide groove 31 (formed only in the upper side in case of FIGS. 4 and 5), and prevents the sliding coupling body 30 from separation as the sliding coupling body 30 excessively slides and moves only in a certain direction.

As described above, the slide-driving rotary body 50 has a structure of screw-coupling with and surrounding the outer screw-coupling portion 37 of the sliding coupling body 30, and rotatably coupling with the rotation guide cylinder 13 and the rotation guide rail 14 of the support bracket 10 without separation. To this end, as described above, the slide-driving rotary body 50 includes the rotation guide supporter 53 and the rotation guide groove 54 on the lower inside thereof respectively corresponding to the rotation guide cylinder 13 and the rotation guide rail 14, and the upper side of the rotation guide groove 54 is formed with the inner screw-coupling portion 57 corresponding to the outer screw-coupling portion 37 of the sliding coupling body 30.

As shown in FIG. 5, the slide-driving rotary body 50 may have a assembled structure of two separable parts. That is, the slide-driving rotary body 50 is formed by assembling two separable bodies of rotation while forming the rotation coupling hole 55 internally penetrated. The rotation coupling hole 55 includes the inner screw-coupling portion 57, the rotation guide supporter 53 and the rotation guide groove 54. The separable bodies of rotation to form the slide-driving rotary body 50 are respectively formed with fastening holes 51, and these fastening holes 51 are fastened with bolts, so that the separable bodies of rotation can be assembled into the slide-driving rotary body.

The foregoing mounting module 100 may be assembled by first arranging the sliding coupling body 30 to penetrate the insertion sliding hole 15 so that the sliding guide groove 31 can engage with and slide along the sliding guide rail 16; making the slide-driving rotary body 50 without fastening the two separable bodies of rotation by the bolts not only screw-couple with the outer screw-coupling portion 37 of the sliding coupling body 30 but also rotatably couple with the rotation guide cylinder 13 and the rotation guide rail 14 without separation; and then fastening the separable bodies of rotation with bolts to form the slide-driving rotary body 50. Like this, the mounting module 100 according to the present disclosure is very easy to assemble, and it is advantageously possible to minimize time and efforts taken in assembling and disassembling the mounting module 100.

In the foregoing terminal supporter mountable to the vehicle ventilator according to the present disclosure, the use aspects of the mounting module 100 will be described with reference to FIG. 6.

To make the assembled mounting module 100 be inserted in and mounted to the vehicle ventilator 1, as shown in (a) of FIG. 6, the first side, i.e. the hook 33 of the sliding coupling body 30 is deeply inserted in the vehicle ventilator 1, and the contact support plate 11 of the support bracket 10 is in contact with and supported on the entrance of the vehicle ventilator 1, i.e. the front end 3b of the ventilator slat 3, thereby making the insertion support piece 12 be inserted between the ventilator slats 3 in the vehicle ventilator 1.

Then, a user rotates the slide-driving rotary body 50 to drive the sliding coupling body 30 slide and move backward (refer to the arrow in (a) of FIG. 6), and, further rotates the slide-driving rotary body 50 to drive the sliding coupling body 30 move backward until the hook 33 of the sliding coupling body 30 strongly pushes the rear end 3b of the ventilator slat 3 (as shown in (b) of FIG. 6) while being hooked to the rear end 3b. Then, the mounting module 100 can keep strongly tightening up the front end 3a and the rear end 3b of the ventilator slat 3 and vertical reinforcement and support using the insertion support piece 12, and thus firmly and stably held within the vehicle ventilator 1.

As described above, according to the present disclosure with the foregoing technical problems and solutions, the terminal supporter mountable to the vehicle ventilator is configured to strongly tighten up the front and rear ends of the ventilator slat after being inserted in the vehicle ventilator, and is thus prevented from separation from and moving or shaking within the vehicle ventilator, thereby having an effect on maintaining a stable and firm mounting state.

Although a few exemplary embodiments of the present disclosure have been shown and described, these are for illustrative purpose only and it will be appreciated by those skilled in the art that changes may be made in these embodiments without departing from the principles and spirit of the invention, the scope of which is defined in the appended claims and their equivalents.

### REFERENCE NUMERALS

| | |
|---|---|
| 1: vehicle ventilator | 3: ventilator slat |
| 3a: front end of ventilator slat | 3b: rear end of ventilator slat |
| 10: support bracket | 11: contact support plate |
| 12: insertion support piece | 13: rotation guide cylinder |
| 14: rotation guide rail | 15: insertion sliding hole |
| 16: sliding guide rail | 30: sliding coupling body |
| 31: sliding guide groove | 32: sliding stopper |
| 33: hook | 35: joint |
| 37: outer screw-coupling portion | |
| 50: slide-driving rotary body | |
| 51: fastening hole | 53: rotation guide supporter |
| 54: rotation guide groove | 55: rotation coupling hole |
| 57: inner screw-coupling portion | |
| 100: mounting module | 300: cradle |

1. A terminal supporter mountable to a vehicle ventilator, which comprises a mounting module inserted in and mounted to the vehicle ventilator, and a cradle connected to the mounting module and supporting and holding a terminal,
the mounting module comprising:
a support bracket including a contact support plate arranged to be in contact with and supported on front ends of ventilator slats from an outside of the vehicle ventilator, an insertion support piece protruding from a first side of the contact support plate and inserted between adjacent ventilator slats, a rotation guide cylinder protruding a second side of the contact support plate, an insertion sliding hole formed inside the rotation guide cylinder, and a sliding guide rail formed in the insertion sliding hole;
a sliding coupling body inserted in the insertion sliding hole, and including a sliding guide groove formed along a longitudinal direction, a sliding stopper formed in a sliding groove, a hook at a first side to be inserted in the vehicle ventilator and hooked to a rear end of the ventilator slat, and a joint at a second side to which the cradle is detachably connected; and
a slide-driving rotary body including an upper portion screw-coupled with the sliding coupling body, and a lower portion rotatably coupled to the rotation guide cylinder, wherein
the sliding guide rail is inserted in the sliding guide groove such that the sliding coupling body is configured to move forward or backward along the sliding guide rail when the slide-driving rotary body rotates, and
the sliding stopper is configured to be in contact with the sliding guide rail when the sliding coupling body moves forward or backward along the sliding guide rail.

2. (canceled)

3. The terminal supporter mountable to the vehicle ventilator according to claim 1, wherein:
the rotation guide cylinder includes a rotation guide rail shaped like a ring laterally protruding from a top end; and
the slide-driving rotary body further includes a rotation guide supporter arranged to be adjacent to and surround the rotation guide cylinder at a lower inside, and a rotation guide groove laterally recessed at an upper end of the rotation guide supporter to accommodate and guide the rotation guide rail.
